(19) United States
(12) Patent Application Publication
(10) Pub. No.: US 2024/0414760 A1
(43) Pub. Date: Dec. 12, 2024

(54) Methods To Reduce Channel Accessing Delay For Bluetooth System Using Listen Before Talk (LBT)

(71) Applicant: MediaTek Inc., Hsinchu City (TW)

(72) Inventors: Tung-Sheng Yang, Hsinchu City (TW); Ting-Che Tseng, Hsinchu City (TW)

(21) Appl. No.: 18/733,863

(22) Filed: Jun. 5, 2024

Related U.S. Application Data
(60) Provisional application No. 63/506,391, filed on Jun. 6, 2023.

(51) Int. Cl. H04W 74/0808; H04W 52/36

(52) U.S. Cl. CPC H04W 74/0808; H04W 52/367

(57) ABSTRACT

Techniques pertaining to methods to reduce channel accessing delay for Bluetooth system using listen before talk (LBT) in wireless communications are described. An apparatus performs LBT on a channel and, based on a result of the LBT, the apparatus transmits on the channel responsive to the channel being deemed unoccupied. In performing the LBT, the apparatus performs the LBT with at least one of: (a) dynamic transmit (Tx) power control (TPC) with an adaptive energy detection (ED) threshold; (b) an extended clear channel assessment (CCA) time; and (c) the extended CCA time with a multi-block format of transmission.

### CROSS REFERENCE TO RELATED PATENT APPLICATION(S)

The present disclosure claims the priority benefit of U.S. Patent Application No. 63/506,391, filed 6 Jun. 2023, the content of which being herein incorporated by reference in its entirety.

### TECHNICAL FIELD

The present disclosure is generally related to wireless communications and, more particularly, to methods to reduce channel accessing delay for Bluetooth system using listen before talk (LBT) in wireless communications.

### BACKGROUND

Unless otherwise indicated herein, approaches described in this section are not prior art to the claims listed below and are not admitted as prior art by inclusion in this section.

In wireless communications, in a Bluetooth system at 2.4 GHz, Detect and Avoid (DAA) is a scheme used for channel access. DAA is defined in EN300328 and is generally considered not a good co-existence protocol. Since 2022, the Bluetooth Special Interest Group (SIG) has been planning to migrate Bluetooth to a higher band, such as UNII-3 (5725˜5850 MHz, for which no LBT is required for a short-range device (SRD)) and UNII-5 (5945˜6425 MHz, for which LBT may be required). The Bluetooth system may use LBT as a channel access mechanism on the 5 GHz/6 GHz band for better co-existence with a Wi-Fi system. However, LBT may cause a large access delay for the Bluetooth system, thereby resulting in poor user experience. Therefore, there is a need for a solution of methods to reduce channel accessing delay for Bluetooth system using LBT.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure pertain to methods to reduce channel accessing delay for Bluetooth system using LBT in wireless communications. It is believed that implementations of the various proposed schemes may address or otherwise alleviate the aforementioned issue(s). For instance, under the proposed schemes, channel access delay in a Bluetooth system may be reduced when the LBT mechanism is employed.

In one aspect, a method may involve performing LBT on a channel. The method may also involve, based on a result of the LBT, transmitting on the channel responsive to the channel being deemed unoccupied. In performing the LBT, the method may involve performing the LBT with at least one of: (a) dynamic transmit (Tx) power control (TPC) with an adaptive energy detection (ED) threshold; (b) an extended clear channel assessment (CCA) time; and (c) the extended CCA time with a multi-block format of transmission.

In another aspect, an apparatus implementable in a UE may include a transceiver configured to communicate wirelessly and a processor coupled to the transceiver. The processor may perform LBT on a channel. The processor may also, based on a result of the LBT, transmit on the channel responsive to the channel being deemed unoccupied. In performing the LBT, the processor may perform the LBT with at least one of: (a) dynamic TPC with an adaptive ED threshold; (b) an extended CCA time; and (c) the extended CCA time with a multi-block format of transmission.

It is noteworthy that, although description provided herein may be in the context of certain radio access technologies, networks, and network topologies for wireless communication, such as 5^{th} Generation (5G)/New Radio (NR) mobile communications, the proposed concepts, schemes and any variation(s)/derivative(s) thereof may be implemented in, for and by other types of radio access technologies, networks and network topologies such as, for example and without limitation, Evolved Packet System (EPS), Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario under a proposed scheme in accordance with the present disclosure.

FIG. 2 is a diagram of an example scenario under a proposed scheme in accordance with the present disclosure.

FIG. 3 is a diagram of an example scenario under a proposed scheme in accordance with the present disclosure.

FIG. 4 is a block diagram of an example communication system under a proposed scheme in accordance with the present disclosure.

FIG. 5 is a flowchart of an example process under a proposed scheme in accordance with the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to methods to reduce channel accessing delay for Bluetooth system using LBT in wireless communications. According to the present disclosure, a number of possible solutions may be implemented separately or jointly. That is, although these possible solutions may be described below separately, two or more of these possible solutions may be implemented in one combination or another.

In general, in LBT (or clear channel access (CCA)), a device listens on a channel or wireless communication medium briefly (e.g., a few microseconds) before transmission, so as to determine whether the channel is currently available or busy. If the channel is busy, the device waits for a certain amount of time before transmission. There are several variants of LBT defined in EN303687. One type of LBT pertains to load-based equipment (LBE), which contends for the medium as soon as the channel becomes idle (e.g., in a Wi-Fi system). Another type of LBT pertains to frame-based equipment (FBE), which contends for the medium only at certain frame interval (e.g., in a Bluetooth system). When LBE (e.g., Wi-Fi) and FBE (e.g., Bluetooth) devices operate on the same channel, FBE devices tend to obtain a smaller share of the channel and, thus, suffer unacceptable access delay.

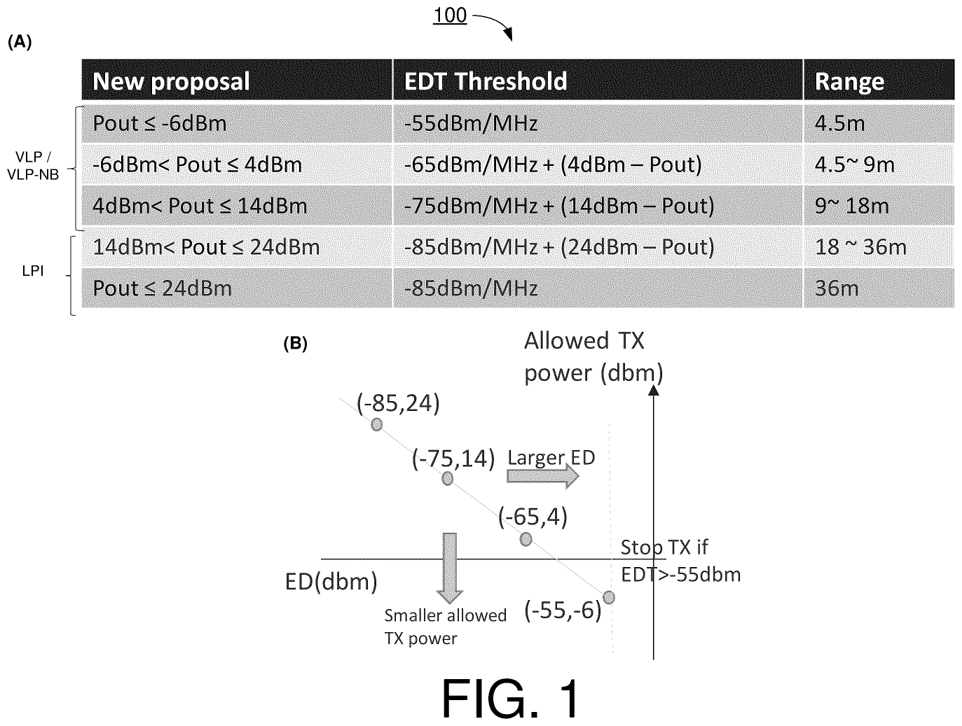

FIG. 1 illustrates an example scenario 100 under a proposed scheme in accordance with the present disclosure. Scenario 100 may pertain to transmit (Tx) power control (TPC) and adaptive energy detection (ED) threshold (EDT). Under the proposed scheme, a wireless-capable (e.g., Bluetooth-capable) device may perform TPC and adaptive EDT to increase opportunity of Bluetooth transmission. According to European Telecommunications Standards Institute (ETSI) EN303687, current EDT is fixed at −75 dBm/MHz if the maximum Tx power (Pₘₐₓ) is less than or equal to Pₘₐₓ≤14 dBm for the 6 GHz band. Under the ETSI definition, a channel is deemed an occupied channel as long as transmissions in the channel are present at a power level greater than the EDT. The power level is determined by integrating the received power over the channel and then normalized to per-MHz power. If no transmissions are present at a power level greater than the EDT, the channel is considered an unoccupied channel (and thus available for transmission). Under the ETSI definition, the EDT is proportional to the equipment's maximum configured transmit power, or Pₘₐₓ, and EDT levels are absolute levels that apply at all times, as follows:

For Pₘₐₓ ≤ 14dBm, EDT = −75dBm/MHz;
For 14dBm < Pₘₐₓ ≤ 24dBm, EDT = −85dBm/MHz + (24dBm − Pₘₐₓ);
and For Pₘₐₓ ≥ 24dBm, EDT = −85dBm/MHz.

Under the proposed scheme, adaptive EDT may be extended to very low power (VLP) such as to a range of 14 dBm˜smaller power, and Pₘₐₓ may be replaced with an instant output power (Pₒᵤₜ) (e.g., the current Pₒᵤₜ at the time of transmission) for Bluetooth Tx power control in performing LBT, as shown in part (A) of FIG. 1. Moreover, the proposed scheme may involve dynamic power control based on energy detection results and adaptive energy detection thresholds to reduce interference to the medium. For instance, smaller allowed Tx power may be utilized for larger energy detection results. Under the proposed scheme, relatively higher Pₒᵤₜ levels and corresponding ED thresholds may be suitable for low power indoor (LPI) applications while relatively lower Pₒᵤₜ levels and corresponding ET thresholds may be suitable for VLP (and VLP-narrowband (VLP-NB)) applications.

Referring to part (B) of FIG. 1, under the proposed scheme, energy detection clear channel access (ED CCA) may be used to determine whether a channel is clear for transmission. Moreover, Tx power control may be per-packet Tx power control depending on medium (air) conditions (e.g., the Tx power used in transmitting each packet may depend on the medium conditions at the time of transmission of the respective packet). For instance, in case that ED (CCA) is less than a first threshold TH1 (e.g., −85 dBm), then Tx power may be greater than 24 dBm. Additionally, in case that ED (CCA) is less than a second threshold TH2 (e.g., −75 dBm), then Tx power may be less than 24 dBm. Also, in case that ED (CCA) is less than a third threshold TH3 (e.g., −65 dBm), then Tx power may be less than 14 dBm. Moreover, in case that ED (CCA) is less than a fourth threshold TH4 (e.g., −55 dBm), then Tx power may be less than 4 dBm. Else, the Tx power may be less than or equal to −6 dMb or there may be no transmission to be performed or otherwise carried out.

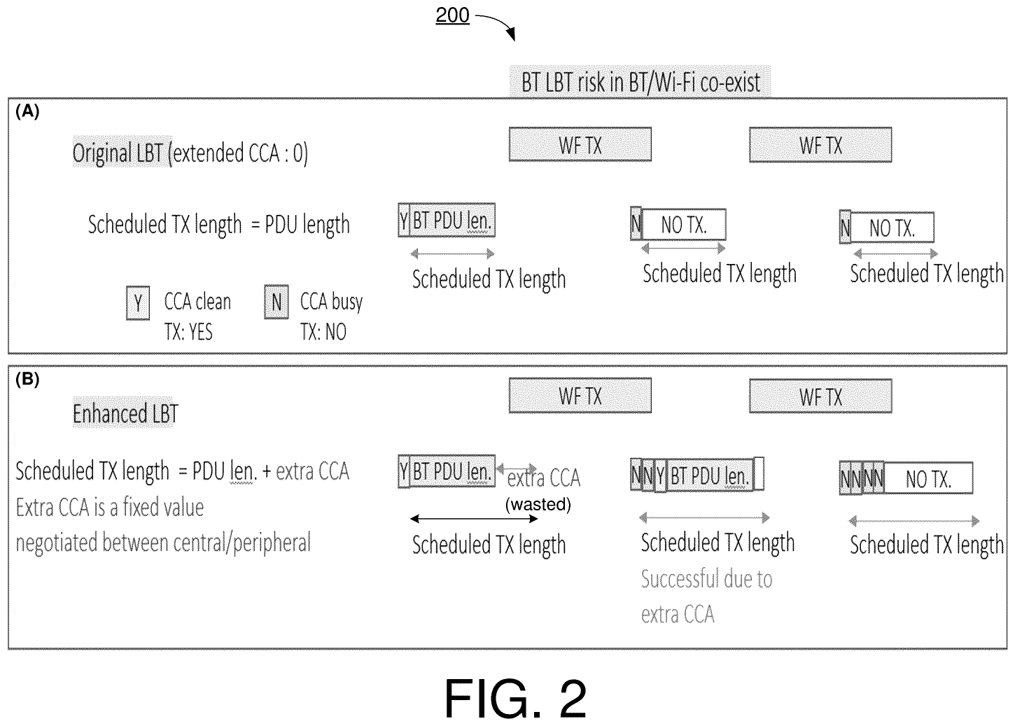

FIG. 2 illustrates an example scenario 200 under a proposed scheme in accordance with the present disclosure. Scenario 200 may pertain to an extended CCA for Bluetooth LBT in a Bluetooth/Wi-Fi co-existing environment. Under the proposed scheme, the time for CCA may be extended to increase the change of obtaining access to a channel. Correspondingly, a protocol data unit (PDU) length may be longer (to result in less extra CCA overhead ratio), and a correspondingly receive (Rx) time (on a receiving end) may need to be increased. Moreover, there may be no extra CCA for any acknowledgement (ACK) packet.

Referring to part (A) of FIG. 2, without implementation of the proposed scheme and under the original LBT design (with no extended CCA time), a Bluetooth PDU may be transmitted upon detection of a clean (or idle) channel based on the result of a one-time energy detection. Conversely, no PDU may be transmitted upon detection of an occupied (or busy) channel based on the result of a one-time energy detection. Consequently, no Bluetooth transmission would be performed even if the channel becomes unoccupied or idle later during a time slot (or scheduled Tx length) that would be used for Bluetooth transmission. The scheduled Tx length is the same as the PDU length.

Referring to part (B) of FIG. 2, under the proposed scheme with an extended CCA time, the scheduled Tx length may be extended to be equal to the PDU length plus an extra CCA time, with the extra CCA time being a difference between the extended CCA time and a non-extended CCA time. The extra CCA time may be a fixed value, which may be negotiated between the transmitting device and the receiving device (e.g., between a central device and a peripheral device), and the resultant extended CCA time may allow performance of energy detection for multiple times (as opposed to one-time energy detection). Under the proposed scheme, a Bluetooth PDU may be transmitted upon detection of a clean (or idle) channel based on the result of one or more energy detections performed during the extended CCA time. That is, the Bluetooth PDU may be transmitted after one or more energy detections during the extended CCA time. Conversely, no PDU may be transmitted upon detection of an occupied (or busy) channel based on the result of all of a plurality of energy detections performed during the extended CCA time.

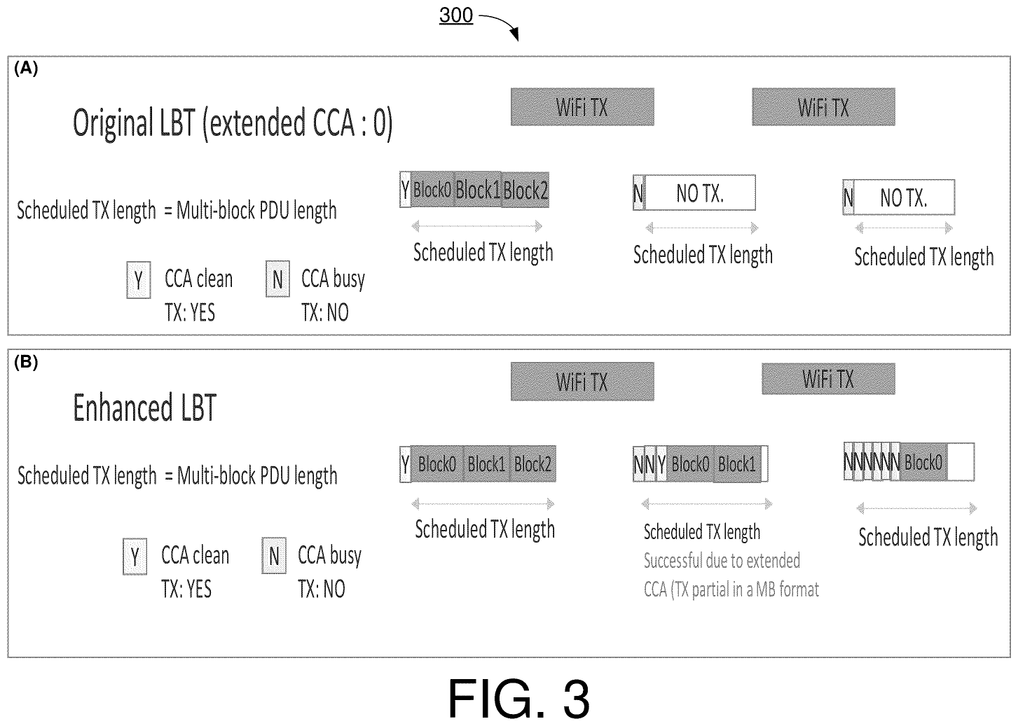

FIG. 3 illustrates an example scenario 300 under a proposed scheme in accordance with the present disclosure. Scenario 300 may pertain to an extended CCA for a multi-block format of transmission for Bluetooth LBT in a Bluetooth/Wi-Fi co-existing environment. Under the proposed scheme, in addition to the time for CCA being extended to increase the change of obtaining access to a channel, transmission of a PDU may be carried out in the form of one or more blocks of multiple blocks corresponding to the PDU or a packet. Thus, when a channel is deemed unoccupied or idle, one or more blocks of multiple blocks corresponding to a PDU or a packet may be transmitted.

Referring to part (A) of FIG. 3, without implementation of the proposed scheme and under the original LBT design (with no extended CCA time), a Bluetooth PDU may be transmitted upon detection of a clean (or idle) channel based on the result of a one-time energy detection. Conversely, no PDU may be transmitted upon detection of an occupied (or busy) channel based on the result of a one-time energy detection. Consequently, no Bluetooth transmission would be performed even if the channel becomes unoccupied or idle later during a time slot (or scheduled Tx length) that would be used for Bluetooth transmission. The scheduled Tx length is the same as the PDU length.

Referring to part (B) of FIG. 3, under the proposed scheme with an extended CCA time, in a multi-block format, the number of scheduled transmission blocks (for transmission) may be reduced for extended CCA. Moreover, the scheduled Tx length may still be the same as the PDU length. Under the proposed scheme, one or more blocks (e.g., block 0, block 1 and block 2) of multiple blocks corresponding to a Bluetooth PDU may be transmitted upon detection of a clean (or idle) channel based on the result of one or more energy detections performed during the extended CCA time. That is, one or more blocks corresponding to the Bluetooth PDU may be transmitted after one or more energy detections during the extended CCA time. As shown in part (B) of FIG. 3, upon detecting the channel being unoccupied or idle after one or more energy detections during the extended CCA time, partial transmission of a PDU in a multi-block format may be performed (e.g., block 0 and block 1 in one instance, and block 0 in another instance).

### Illustrative Implementations

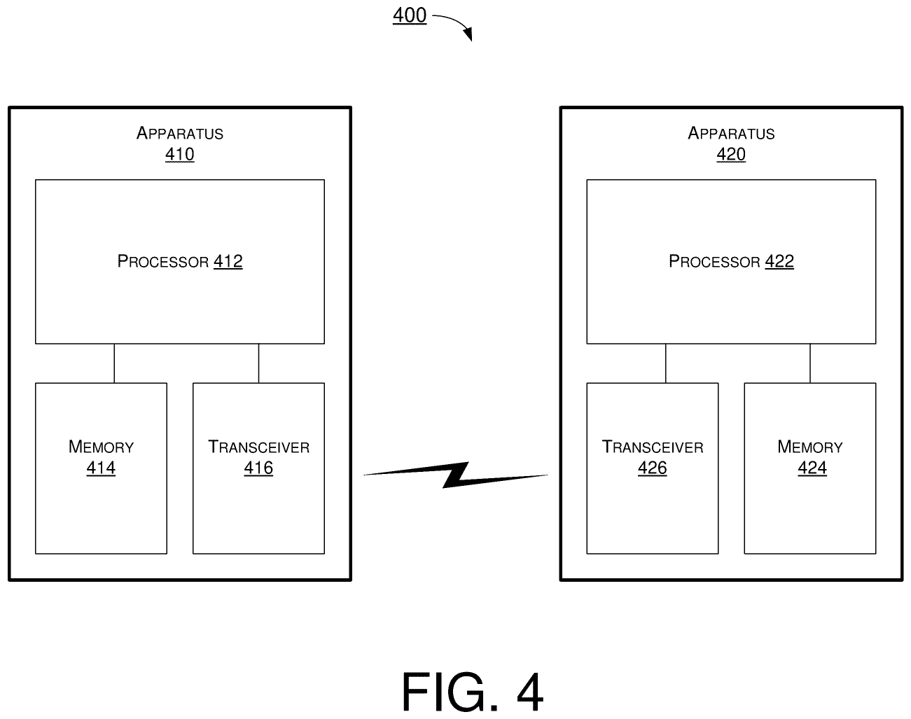

FIG. 4 illustrates an example communication system 400 having at least an example apparatus 410 and an example apparatus 420 in accordance with an implementation of the present disclosure. Each of apparatus 410 and apparatus 420 may perform various functions to implement schemes, techniques, processes and methods described herein pertaining to methods to reduce channel accessing delay for Bluetooth system using LBT in wireless communications, including the various schemes described above with respect to various proposed designs, concepts, schemes, systems and methods described above, as well as processes described below.

Each of apparatus 410 and apparatus 420 may be a part of an electronic apparatus, which may be a network apparatus or a user equipment (UE) device or Wi-Fi station (STA), such as a portable or mobile apparatus, a wearable apparatus, a vehicular device or a vehicle, a wireless communication apparatus or a computing apparatus. For instance, each of apparatus 410 and apparatus 420 may be implemented in a smartphone, a smartwatch, a personal digital assistant, an electronic control unit (ECU) in a vehicle, a digital camera, or a computing equipment such as a tablet computer, a laptop computer or a notebook computer. Each of apparatus 410 and apparatus 420 may also be a part of a machine type apparatus, which may be an IoT apparatus such as an immobile or a stationary apparatus, a home apparatus, a roadside unit (RSU), a wire communication apparatus, or a computing apparatus. For instance, each of apparatus 410 and apparatus 420 may be implemented in a smart thermostat, a smart fridge, a smart door lock, a wireless speaker or a home control center.

In some implementations, each of apparatus 410 and apparatus 420 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 410 and apparatus 420 may be implemented in or as a network apparatus or a UE. Each of apparatus 410 and apparatus 420 may include at least some of those components shown in FIG. 4 such as a processor 412 and a processor 422, respectively, for example. Each of apparatus 410 and apparatus 420 may further include one or more other components not pertinent to the proposed scheme of the present disclosure (e.g., internal power supply, display device and/or user interface device), and, thus, such component(s) of apparatus 410 and apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC or RISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including those pertaining to methods to reduce channel accessing delay for Bluetooth system using LBT in wireless communications in accordance with various implementations of the present disclosure.

In some implementations, apparatus 410 may also include a transceiver 416 coupled to processor 412. Transceiver 416 may be capable of wirelessly transmitting and receiving data. In some implementations, transceiver 416 may be capable of wirelessly communicating with different types of wireless networks of different radio access technologies (RATs) such as, for example, Bluetooth and Wi-Fi. In some implementations, transceiver 416 may be equipped with a plurality of antenna ports (not shown) such as, for example, four antenna ports. That is, transceiver 416 may be equipped with multiple transmit antennas and multiple receive antennas for multiple-input multiple-output (MIMO) wireless communications. In some implementations, apparatus 420 may also include a transceiver 426 coupled to processor 422. Transceiver 426 may include a transceiver capable of wirelessly transmitting and receiving data.

In some implementations, apparatus 410 may further include a memory 414 coupled to processor 412 and capable of being accessed by processor 412 and storing data therein. In some implementations, apparatus 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

Each of apparatus 410 and apparatus 420 may be a communication entity capable of communicating with each other using various proposed schemes in accordance with the present disclosure. For illustrative purposes and without limitation, a description of capabilities of apparatus 410 and apparatus 420 is provided below in the context of example process 500.

### Illustrative Processes

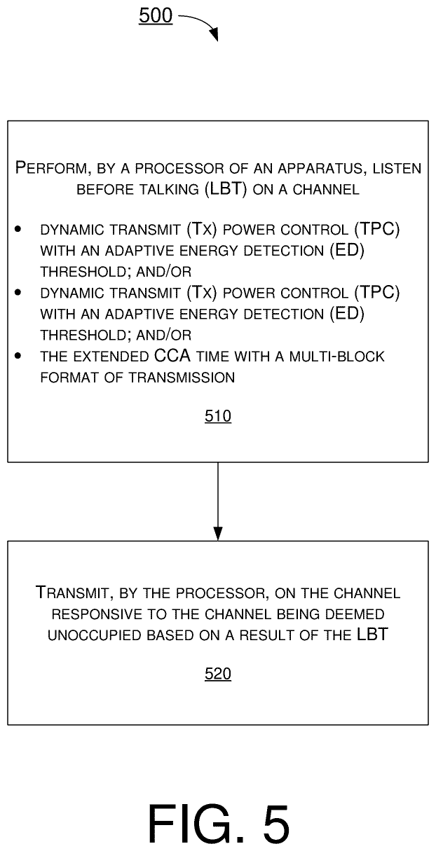

FIG. 5 illustrates an example process 500 in accordance with an implementation of the present disclosure. Process 500 may represent an aspect of implementing various proposed designs, concepts, schemes, systems and methods described above pertaining to methods to reduce channel accessing delay for Bluetooth system using LBT in wireless communications, whether partially or entirely, including those pertaining to those described above. Process 500 may include one or more operations, actions, or functions as illustrated by one or more of blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure, or, alternatively in a different order. Furthermore, one or more of the blocks/sub-blocks of each process may be executed iteratively. Process 500 may be implemented by or in apparatus 410 and/or apparatus 420 as well as any variations thereof. Process 500 may begin at block 510.

At 510, process 500 may involve processor 412 of apparatus 410 performing, via transceiver 416, LBT on a channel. For instance, process 500 may involve processor 412 performing the LBT with at least one of the following: (a) dynamic TPC with an adaptive ED threshold; (b) an extended CCA time; and (c) the extended CCA time with a multi-block format of transmission. Process 500 may proceed from 510 to 520.

At 520, process 500 may involve processor 412 transmitting, via transceiver 416, on the channel responsive to the channel being deemed unoccupied based on a result of the LBT.

In some implementations, in performing the LBT with the dynamic TPC with the adaptive ED threshold, process 500 may involve processor 412 performing certain operations. For instance, process 500 may involve processor 412 detecting a medium condition of the channel. Additionally, process 500 may involve processor 412 determining an ED threshold based on the detected medium condition of the channel. Moreover, process 500 may involve processor 412 adjusting a Tx power corresponding to the determined ED threshold. In some implementations, in adjusting the Tx power corresponding to the determined ED threshold, process 500 may involve processor 412 performing certain operations. For instance, process 500 may involve processor 412 transmitting a packet at a relatively higher Tx power responsive to the determined ED threshold being a relatively higher ED threshold. Furthermore, process 500 may involve processor 412 transmitting the packet at a relatively lower Tx power responsive to the determined ED threshold being a relatively lower ED threshold.

In some implementations, in performing the LBT with the dynamic TPC, process 500 may involve processor 412 dynamically controlling a Tx power on a per-packet basis and based on a medium condition of the channel.

In some implementations, in performing the LBT with the dynamic TPC with the adaptive ED threshold, process 500 may involve processor 412 determining an ED threshold according to an output power (Pₒᵤₜ) in the transmitting. For instance, for Pₒᵤₜ≤−6 dBm, the ED threshold=−55 dBm/MHz; for −6 dBm<Pₒᵤₜ<4 dBm, the ED threshold=−65 dBm/MHz+(4 dBm−Pₒᵤₜ); for 4 dBm<Pₒᵤₜ≤14 dBm, the ED threshold=−75 dBm/MHz+(14 dBm−Pₒᵤₜ);
for 14 dBm<Pₒᵤₜ≤24 dBm, the ED threshold=−85 dBm/MHz+(24 dBm−Pₒᵤₜ); and for Pₒᵤₜ≤24 dBm, the ED threshold=−85 dBm/MHz.

In some implementations, the extended CCA time may allow performing of energy detection for multiple times for the LBT. Correspondingly, in transmitting, process 500 may involve processor 412 transmitting responsive to the channel being deemed unoccupied based on a result of one or more energy detections performed during the extended CCA time. In some implementations, a scheduled transmission time for the transmitting is equal to a PDU length plus an extra CCA time. Moreover, the extra CCA time may be a difference between the extended CCA time and a non-extended CCA time.

In some implementations, the extended CCA time may allow performing of energy detection for multiple times for the LBT. Correspondingly, in transmitting with the multi-block format, process 500 may involve processor 412 transmitting one or more blocks of multiple blocks corresponding to a packet or a PDU responsive to the channel being deemed unoccupied based on a result of one or more energy detections performed during the extended CCA time. In some implementations, a scheduled transmission time for the transmitting may be equal to a PDU length. Furthermore, the extra CCA time may be a difference between the extended CCA time and a non-extended CCA time.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of an apparatus, listen before talking (LBT) on a channel; and
transmitting, by the processor, on the channel responsive to the channel being deemed unoccupied based on a result of the LBT,
wherein the performing of the LBT comprises performing the LBT with at least one of:
dynamic transmit (Tx) power control (TPC) with an adaptive energy detection (ED) threshold;
an extended clear channel assessment (CCA) time; and
the extended CCA time with a multi-block format of transmission.

2. The method of claim 1, wherein the performing of the LBT with the dynamic TPC with the adaptive ED threshold comprises:
detecting a medium condition of the channel;
determining an ED threshold based on the detected medium condition of the channel; and
adjusting a Tx power corresponding to the determined ED threshold.

3. The method of claim 2, wherein the adjusting of the Tx power corresponding to the determined ED threshold comprises:
transmitting a packet at a relatively higher Tx power responsive to the determined ED threshold being a relatively higher ED threshold; and
transmitting the packet at a relatively lower Tx power responsive to the determined ED threshold being a relatively lower ED threshold.

4. The method of claim 1, wherein the performing of the LBT with the dynamic TPC comprises dynamically controlling a Tx power on a per-packet basis and based on a medium condition of the channel.

5. The method of claim 1, wherein the performing of the LBT with the dynamic TPC with the adaptive ED threshold comprises determining an ED threshold according to an output power (Pₒᵤₜ) in the transmitting.

6. The method of claim 5, wherein:
for Pₒᵤₜ ≤ −6dBm, the ED threshold = −55dBm/MHz;
for −6dBm < Pₒᵤₜ ≤ 4dBm, the ED threshold = −65dBm/MHz + (4dBm −
Pₒᵤₜ); for 4dBm < Pₒᵤₜ ≤ 14dBm, the ED threshold = −75dBm/MHz +
(14dBm − Pₒᵤₜ); for 14dBm < Pₒᵤₜ ≤ 24dBm, the ED
threshold = −85dBm/MHz + (24dBm − Pₒᵤₜ); and for Pₒᵤₜ ≤ 24dBm,
the ED threshold = −85dBm/MHz.

7. The method of claim 1, wherein the extended CCA time allows performing of energy detection for multiple times for the LBT, and wherein the transmitting comprises transmitting responsive to the channel being deemed unoccupied based on a result of one or more energy detections performed during the extended CCA time.

8. The method of claim 7, wherein a scheduled transmission time for the transmitting is equal to a protocol data unit (PDU) length plus an extra CCA time, and wherein the extra CCA time is a difference between the extended CCA time and a non-extended CCA time.

9. The method of claim 1, wherein the extended CCA time allows performing of energy detection for multiple times for the LBT, and wherein the transmitting with the multi-block format comprises transmitting one or more blocks of multiple blocks corresponding to a packet or a protocol data unit (PDU) responsive to the channel being deemed unoccupied based on a result of one or more energy detections performed during the extended CCA time.

10. The method of claim 9, wherein a scheduled transmission time for the transmitting is equal to a PDU length, and wherein the extra CCA time is a difference between the extended CCA time and a non-extended CCA time.

11. An apparatus, comprising:
a transceiver configured to communicate wirelessly; and
a processor coupled to the transceiver and configured to perform operations comprising:
performing, via the transceiver, listen before talk (LBT) on a channel; and
transmitting, via the transceiver, on the channel responsive to the channel being deemed unoccupied based on a result of the LBT,
wherein the performing of the LBT comprises performing the LBT with at least one of:
dynamic transmit (Tx) power control (TPC) with an adaptive energy detection (ED) threshold;
an extended clear channel assessment (CCA) time; and
the extended CCA time with a multi-block format of transmission.

12. The apparatus of claim 11, wherein the performing of the LBT with the dynamic TPC with the adaptive ED threshold comprises:
detecting a medium condition of the channel;
determining an ED threshold based on the detected medium condition of the channel; and
adjusting a Tx power corresponding to the determined ED threshold.

13. The apparatus of claim 12, wherein the adjusting of the Tx power corresponding to the determined ED threshold comprises:
transmitting a packet at a relatively higher Tx power responsive to the determined ED threshold being a relatively higher ED threshold; and
transmitting the packet at a relatively lower Tx power responsive to the determined ED threshold being a relatively lower ED threshold.

14. The apparatus of claim 11, wherein the performing of the LBT with the dynamic TPC comprises dynamically controlling a Tx power on a per-packet basis and based on a medium condition of the channel.

15. The apparatus of claim 11, wherein the performing of the LBT with the dynamic TPC with the adaptive ED threshold comprises determining an ED threshold according to an output power (Pₒᵤₜ) in the transmitting.

16. The apparatus of claim 15, wherein:
for Pₒᵤₜ ≤ −6dBm, the ED threshold = −55dBm/MHz;
for −6dBm < Pₒᵤₜ ≤ 4dBm, the ED threshold = −65dBm/MHz +
(4dBm − Pₒᵤₜ); for 4dBm < Pₒᵤₜ ≤ 14dBm, the ED
threshold = −75dBm/MHz + for 14dBm < Pₒᵤₜ ≤ 24dBm, the ED
threshold = −85dBm/MHz + (24dBm − (14dBm − Pₒᵤₜ); Pₒᵤₜ); and for
Pₒᵤₜ ≤ 24dBm, the ED threshold = −85dBm/MHz.

17. The apparatus of claim 11, wherein the extended CCA time allows performing of energy detection for multiple times for the LBT, and wherein the transmitting comprises transmitting responsive to the channel being deemed unoccupied based on a result of one or more energy detections performed during the extended CCA time.

18. The apparatus of claim 17, wherein a scheduled transmission time for the transmitting is equal to a protocol data unit (PDU) length plus an extra CCA time, and wherein the extra CCA time is a difference between the extended CCA time and a non-extended CCA time.

19. The apparatus of claim 11, wherein the extended CCA time allows performing of energy detection for multiple times for the LBT, and wherein the transmitting with the multi-block format comprises transmitting one or more blocks of multiple blocks corresponding to a packet or a protocol data unit (PDU) responsive to the channel being deemed unoccupied based on a result of one or more energy detections performed during the extended CCA time.

20. The apparatus of claim 19, wherein a scheduled transmission time for the transmitting is equal to a PDU length, and wherein the extra CCA time is a difference between the extended CCA time and a non-extended CCA time.
